(19) United States
(12) Patent Application Publication
(10) Pub. No.: US 2010/0304869 A1
(43) Pub. Date: Dec. 2, 2010

(54) SYNTHETIC ENVIRONMENT BROADCASTING

(75) Inventors: Robert Ernest Lee, Austin, TX (US); Jean M. Giarrusso, Palo Alto, CA (US); Peter Chi-Hao Huang, Menlo Park, CA (US); Erin Turner, San Francisco, CA (US)

Correspondence Address: Kokka & Backus, PC;Suite 103, 200 Page Mill Road, Palo Alto, CA, 94306, US

(73) Assignee: Trion World Network, Inc., Redwood City, CA (US)

(21) Appl. No.: 12/716,250

(22) Filed: Mar. 2, 2010

Related U.S. Application Data
(60) Provisional application No. 61/183,531, filed on Jun. 2, 2009.

(51) Int. Cl. A63F 9/24; G06F 15/16; H04N 7/12; A63F 13/00

(52) U.S. Cl. 463/42; 709/203; 375/240.01; 463/1; 375/E07.001

(57) ABSTRACT

Synthetic environment broadcasting is described, including receiving an input from a client indicating a request to retrieve data associated with a synthetic environment, using an emulated game client to capture data in a first display perspective associated with the synthetic environment, graphically encoding the data captured by the emulated game client using a graphics engine, the data being encoded into a graphical format, transmitting the data from the graphics engine to a video encoding server, broadcasting the data after being encoded by the video encoding server to the client in response to the request, the data being broadcast in substantially real-time by the video encoding server, and presenting the data being broadcast on the client, wherein the data is rendered on the client in a second display perspective that is substantially similar to the first display perspective.

### CROSS REFERENCE TO RELATED APPLICATIONS

This application claims priority to U.S. Provisional Patent Application No. 61/183,531 (Docket No.: TRI-012P) entitled “Synthetic Environment Broadcasting” filed Jun. 2, 2009, which is incorporated herein by reference for all purposes.

### FIELD

The present invention relates generally to software, computer program architecture, and data network communications. More specifically, techniques for synthetic environment broadcasting are described.

### BACKGROUND

Economic growth in the video games and gaming industries are typically dependent upon the rapid and widespread adoption of titles, genres, or episodic releases in games. New graphical and visual displays, enhanced features, or new functions are often included in successive releases of games in order to strengthen consumer adoption. However, growing distribution of computing devices such as desktop computers, mobile computing devices, personal digital assistants (PDAs), smart phones (e.g., iPhone® developed by Apple, Incorporated of Cupertino, Calif., and others), set top boxes, servers, and networked game consoles are enabling video games and gaming systems such as massively multiplayer online gaming (MMOGs) for interaction beyond home computers and game console systems. In conventional solutions, users can interact with games and game environments although interaction is typically very limited and technically restricted.

In conventional solutions, users often interact with large scale virtual environments or worlds that are implemented using technically complex client server systems. Clients (i.e., applications installed on a computing device that are configured to allow for gaming or game environment interaction) are typically used to access virtual games or worlds by logging in. However, there are very few game features that allow users to interact or view a game environment without logging into a game. For example, if a user wishes to view a game event or a portion of a gaming environment, conventional solutions typically rely upon the use of still “slide show”-type implementations that typically have low or no interactive features and are provided for informational uses only. Further, conventional solutions are typically slow and latent, often providing glimpses of a virtual world or environment that is substantially late and not real-time. In other words, conventional solutions for observing events within a virtual environment or world are slow, unappealing, technically limited, and cumbersome to implement given the number and variety of differentiated computing devices available.

Thus, what is needed is a solution for interacting with a virtual environment or world without the limitations of conventional techniques.

### BRIEF DESCRIPTION OF THE DRAWINGS

Various embodiments of the invention are disclosed in the following detailed description and the accompanying drawings:

FIG. 1 illustrates an exemplary system for synthetic environment broadcasting;

FIG. 2 illustrates an exemplary application architecture for synthetic environment broadcasting;

FIG. 3 illustrates an alternative exemplary application architecture for synthetic environment broadcasting;

FIG. 4 illustrates another alternative exemplary application architecture for synthetic environment broadcasting;

FIG. 5 illustrates an exemplary spectator view of synthetic environment broadcasting from the perspective of an emulated game client and camera script;

FIG. 6 illustrates an exemplary spectator view of synthetic environment broadcasting from the perspective of a broadcast-receiving client;

FIG. 7 illustrates an exemplary process for synthetic environment broadcasting;

FIG. 8 illustrates another exemplary process for synthetic environment broadcasting; and

FIG. 9 illustrates an exemplary computer system suitable for synthetic environment broadcasting.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, FleX™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement the described techniques. The described techniques may be varied and are not limited to the examples or descriptions provided.

Techniques for synthetic environment broadcasting are described. In some examples, an emulated game client may be configured to capture and encode video or other data that may be streamed or otherwise transmitted to a video encoding server. Once modified, encoded, or otherwise adapted by a video encoding server, video or other type of data may be broadcast to one or more clients when requested (i.e., a hyperlink to a destination or source is selected or activated by a user requesting to see a broadcast of an in-game (i.e., within a synthetic environment) event. As used herein, synthetic environment may refer to any type of virtual world or environment that has been instanced using, for example, the techniques described in U.S. patent application Ser. No. 11/715,009 (Attorney Docket No. TRI-001), entitled “Distributed Network Architecture for Introducing Dynamic Content into a Synthetic Environment,” filed Sep. 6, 2007, which is incorporated by reference herein for all purposes. In other words, events occurring within a synthetic environment may be broadcast to users in real-time or substantially real-time (i.e., within 15 seconds or less of an event occurrence within a synthetic environment), showing a “live” video feed of the event as it occurs. In other examples, controls may be provided that also allow users to record, stop, play, pause, or perform other control functions associated with the rendering, display, and presentation of data broadcast from a synthetic environment using the techniques described herein. The following techniques are described for purposes of illustrating inventive techniques without limitation to any specific examples shown or described.

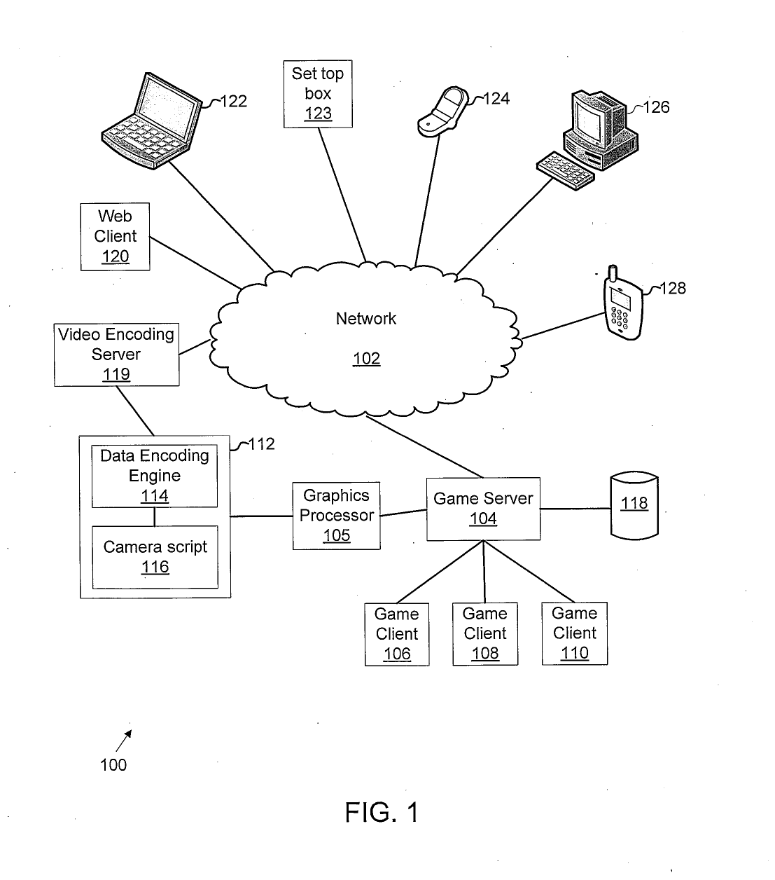

FIG. 1 illustrates an exemplary system for synthetic environment broadcasting. Here, system 100 includes network 102, game server 104, graphics processor 105, game clients 106-110, encoder 112, data (e.g., video, audio, multimedia, or other types of data) encoding engine 114, camera script 116, game database 118, video encoding server 119, web client 120, and clients 122-128. In some examples, the above-listed may be varied in quantity, configuration, type, functionality, or other aspects without limitation to the examples shown and described. As shown, an event occurring within a synthetic environment generated by game server 104 may be viewed on game clients 106-110. However, other clients (e.g., web client 120 and clients 122-128) may also be configured to view an event occurring in real-time or substantially real-time using system 100.

For example, encoder 112 may be a graphics encoding engine, encoding module, encoding server, video encoding server, or other type of encoding mechanism, application, or implementation that is configured to produce graphical and visual representations based on data associated with an event occurring within a synthetic environment generated by game server 104 and, in some examples, stored in game database 118. Data may be encoded as it is received from graphics processor 105, which may be implemented using any type of graphics engine, processor, or the like. Once encoded by encoder 112, data may be sent to video encoding server 119, which may be in data communication with one or more of web client 120 and clients 122-128. In some examples, a web application server (not shown) may also be implemented to provide data encoding for presentation, retrieval, display, rendering, or other operations within a web browser. Once encoded for video broadcasting by video encoding server 119, data may be transmitted over network 102 to one or more of web client 120 and clients 122-128. Alternatively, video encoding server 119 may also be configured to encode different data types for audio, multimedia, or other types of data to be presented on one or more of web client 120 and clients 122-128. Here, the above-described system may be used to implement real-time or substantially real-time broadcasting of data, information, or content associated with an event occurring within a synthetic environment to one or more of web client 120 and clients 122-128. The number, type, configuration, functions, or other features associated with web client 120 and clients 122-128 may be varied beyond the examples shown and described. Further, system 100 and any of the above-described elements may be varied in function, structure, configuration, implementation, or other aspects and are not limited to the examples shown and described.

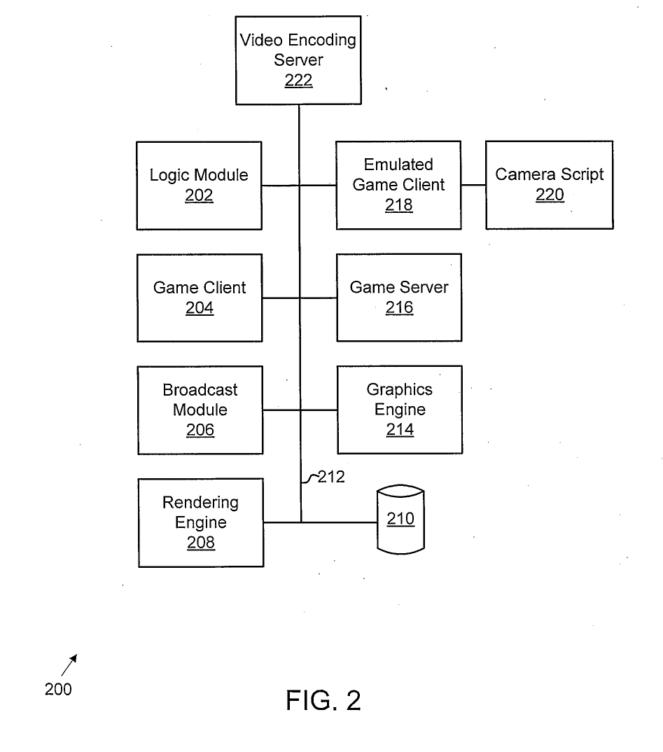

FIG. 2 illustrates an exemplary application architecture for synthetic environment broadcasting. Here, application 200 includes logic module 202, game client 204, broadcast module 206, rendering engine 208, game database 210, message bus 212, graphics engine 214, game server 216, emulated game client 218, camera script 220, and video encoding server 222. In some examples, application 200 may be implemented as a standalone application on a single server instance or as a distributed application using, for example, a service oriented architecture (e.g., SOA), web services distributed (e.g., WSDL), or other type of application architecture, without limitation. Further, the number, type, configuration, function, or other aspects of the above-listed elements may be varied and are not limited to the examples shown and described.

Here, logic module 202 may be configured to provide control signals, data, and instructions to one or more of game client 204, broadcast module 206, rendering engine 208, game database 210, data bus 212, graphics engine 214, game server 216, emulated game client 218, camera script 220, and video encoding server 222. As shown, emulated game client 218 and camera script 220 may be used to capture data associated with an event occurring within a synthetic environment. A synthetic environment and events occurring within or without the synthetic environment may be generated using processes instantiated on game server 216 and game database 210. Further, when generated, data associated with events occurring within a synthetic environment (i.e., event data) may be “captured” by emulated game client 218 and camera script 220. In some examples, events may be made available to emulated game client 218, which is simulating a game client in order to view data associated with events, characters, or other aspects of a synthetic environment. In other words, emulated game client 218 may be emulating a game client (e.g., game client 204) logged into a synthetic environment, which is configured to record or capture data using camera script 220, which may be implemented according to one or more objects or object specifications associated with a property class system that is used to instantiate a synthetic environment and processes associated with it. More details associated with a property class system may be found in U.S. patent application Ser. No. 11/715,009, which is incorporated herein for all purposes.

As shown, camera script 220 may be a script, program, or application written in any type of programming or formatting language to enable features and functions for capturing data associated with an event occurring within a synthetic environment. In some examples, camera script is configured to record data associated with a synthetic environment using the display perspective presented to emulated game client 218. As used herein, “display perspective” may refer to the camera angle, perspective, position, or other parameters (e.g., Cartesian coordinates (e.g., X, Y, and Z axes coordinates), pitch, roll, yaw) from which data is captured. In other words, display perspective may refer to the perceived view of emulated game client 218. When captured by camera script 220, data may be transmitted over data bus 212 to one or more of logic module 202, game client 204, broadcast module 206, rendering engine 208, game database 210, message bus 212, graphics engine 214, game server 216, or video encoding server 222.

In some examples, data associated with an event occurring within a synthetic environment may be rendered using rendering engine 208 and graphics engine 214, the latter of which may interpret data provided by game server 216, game client 204, and game database 210 in order to instantiate a synthetic environment. When data is presented for display on, for example, game client 204 or emulated game client 218, camera script 220 captures the data and transmits it to video encoding server 222, which subsequently encodes and transmits the data to broadcast module 206 for transmission to clients that may or may not be logged into a synthetic environment. In other words, a client does not need to be logged into a game or synthetic environment in order to receive a broadcast from video encoding server 222. Using high bandwidth capacities (i.e., greater than 13.3 kilobits/second) in telecommunications networks and data encapsulation protocols such as universal datagram protocol (“UDP”), transmission control protocol (“TCP”), Internet protocol (“IP”), or others, the techniques described herein may be used to provide a broadcast, data stream, or feed of data associated with a synthetic environment. In other examples, application 200 and the above-described elements may be varied in function, structure, configuration, quantity, or other aspects and are not limited to the descriptions provided.

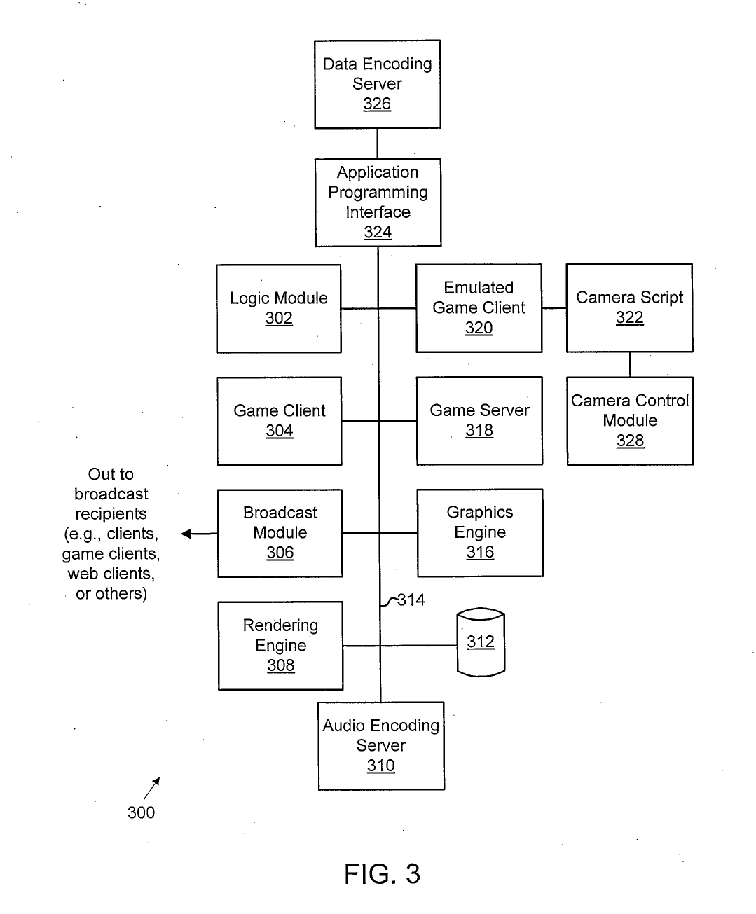

FIG. 3 illustrates an alternative exemplary application architecture for synthetic environment broadcasting. Here, application 300 includes logic module 302, game client 304, broadcast module 306, rendering engine 308, audio encoding server 310, game database 312, data bus 314, graphics engine 316, game sever 318, emulated game client 320, camera script 322, camera control module 328, application programming interface 324, and data encoding server 326. As shown and described above in connection with FIG. 2, logic module 302, game client 304, broadcast module 306, rendering engine 308, game database 312, data bus 314, graphics engine 316, game sever 318, emulated game client 320, and camera script 322 may be implemented similarly or substantially similar to like-named elements. In other examples, application 300 and the above-listed elements may be varied in function, structure, configuration, type, implementation, or other aspects and are not limited to the descriptions provided.

Referring back to FIG. 3, alternative or supplemental functions may be included with application 300. For example, data encoding server 326 may be implemented to encode any type of data, including, but not limited to, video, audio, multimedia, graphical, or others. Further, data encoding server 326 may be implemented using any type of data or content encoding server, such as Video Encoding Server (VES) developed by Oracle® Corporation of Redwood Shores, Calif. In some examples, data encoding server 326 may be used in direct or indirect network communication with an application programming interface 324 to transmit, transfer, or otherwise exchange data with broadcast recipients (e.g., clients, web clients, game clients, or others). Still further, data encoding server 326 may be implemented with, but is not required to have, one or more application programming interfaces in order to process data sent to or from data encoding server 326.

Here, application 300 may be implemented as a standalone or distributed application, with each of the elements shown being in data communication directly or indirectly with each other. In some examples, emulated game client 320 and camera script 322 may be implemented with camera control module 328 that enables, for example game server 318 or game client 304 to control various aspects of data being broadcast from a synthetic environment. For example, video data broadcast by application 300 to game client 304 may have camera options presented such as “record,” “play,” “stop,” “pause,” “forward,” “fast forward,” “rewound,” “fast rewind,” or others. Still further, camera control module 328 may be used to implement controls for system administrators logged into game server 318 to control the angle, direction, speed, height, pan, zoom, or other aspects or features of video data recorded (i.e., captured) by emulated game client 320 and camera script 322. Still further, camera control module 328 may also be used to configure controls, rules, restrictions, limitations, or other features that would allow/disallow various types of users (i.e., game clients) from accessing content provided by data encoding sever 326. As another alternative, audio encoding server 310 may be implemented to encode audio data for inclusion with video data to be broadcast. In other words, video and audio data associated with an event occurring within a synthetic environment may be broadcast using data encoding server and/or audio encoding server 310.

As an example, video and audio data capture of a battle taking place within a synthetic environment may be performed using emulated game client 320 and camera script 322. Using data encoding server 326 and/or audio encoding server 310, data may encoded and sent to broadcast module 306. Subsequently, broadcast module 306 may be configured as a communication interface to, for example, a web application server using one or more application programming interfaces (APIs) or other facilities for transmitting data to a client, game client, web client, or others. In other examples, application 300 and the above-described elements may be varied in function, structure, configuration, or other aspects and are not limited to the descriptions provided.

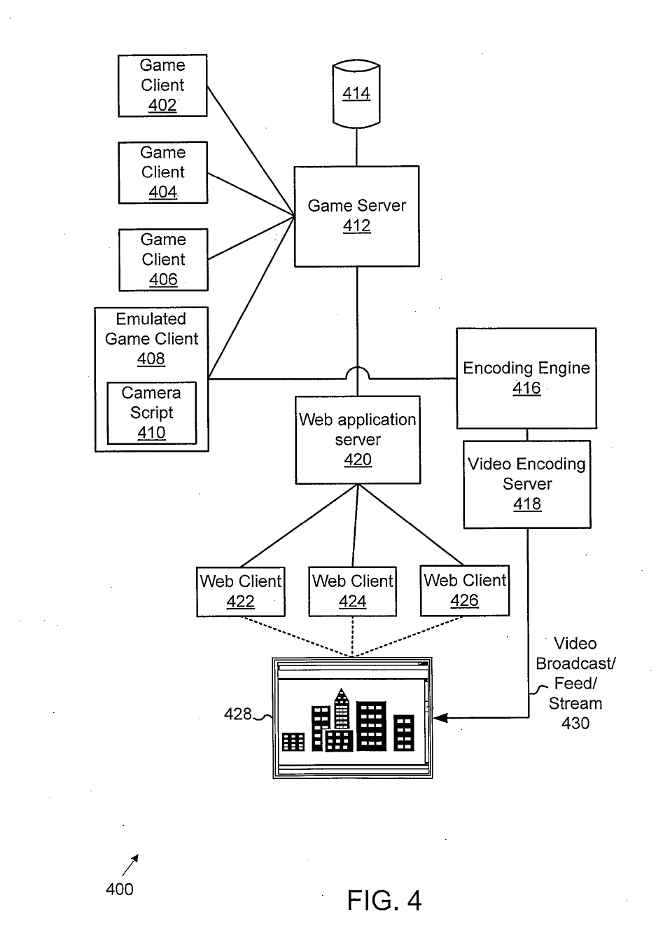

FIG. 4 illustrates another alternative exemplary application architecture for synthetic environment broadcasting. Here, application 400 includes game clients 402-406, emulated game client 408 (configured to implement camera script 410), game server 412, game database 414, encoding engine 416, video encoding server 418, web application server 420, web clients 422-428, graphical user interface (hereafter referred to as “GUI” or “interface”), and video broadcast/feed/stream 430. In some examples, an event occurring within a synthetic environment (e.g., MMOG, MMO Real Time Strategy (MMORTS), MMO Role Playing Game (MMORPG), MMO First Person Shooter (MMOFPS), and others) may be viewed on game clients 402-406 and emulated game client 408. The synthetic environment may be presented on a display associated with each of game clients 402-406 and emulated game client 408, the latter of which uses a scripting program or application (i.e., camera script) to record the synthetic environment. In some examples, adjust of various parameters such as pitch, yaw, roll, or Cartesian coordinates or other coordinates to reference the point of view of a “camera” or recorded/captured display perspective by camera script 410 may be manipulated. Once captured, data may be transmitted to encoding engine 416, which is configured to encode the data from camera script 410 into rendered graphics using indicated parameters. Once generated using encoding engine 416, generated graphics may be sent to video encoding server 418 that further encodes the data for streaming, feeding, or otherwise broadcasting the data for presentation on interface 428, which may be implemented on each of web clients 422-426. Further, other data may be generated from game server 412 and game database 414 and provided to one or more of web clients 422-426 using web application server 420. In other examples, application 400 and the above-described elements may be varied and are not limited to the functions, features, descriptions, structure, or other aspects provided.

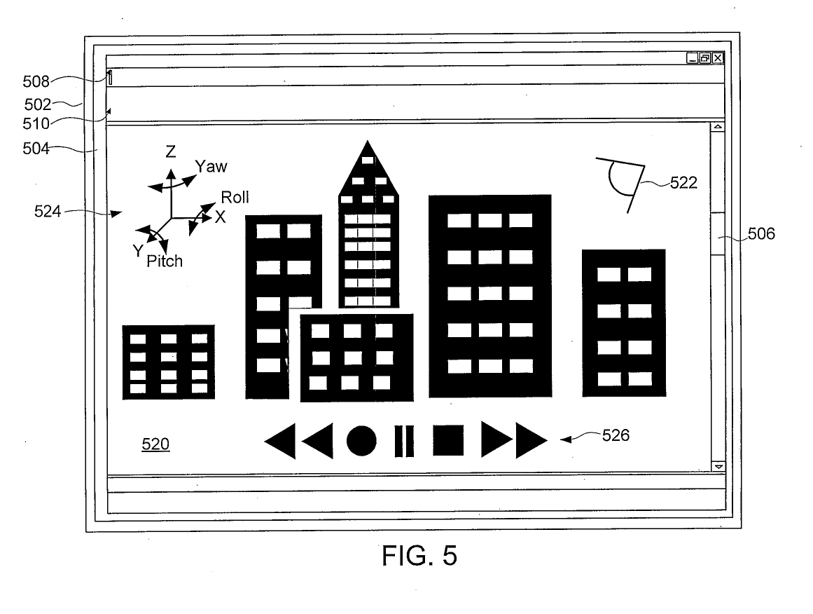

FIG. 5 illustrates an exemplary spectator view of synthetic environment broadcasting from the perspective of an emulated game client and camera script. Here, interface 502 includes window 504, scroll bar 506, regions 508-510, display 520, camera 522, display perspective parameters 524, and camera controls 526. In some examples, interface 502 may be presented on a game client, web client, or any other type of client configured to receive a broadcast, stream, or feed of data from a synthetic environment. Display perspective parameters 524 are provide for explanatory purposes to illustrate different types of parameters that may be used to configure a camera angle associated with camera 522. Although shown in this example, display perspective parameters 524 may not be presented in connection with a display on interface 502, but are presented in display 520 for purposes of illustrating the different types of parameters that may be adjusted to alter the angle of camera 522. For example, camera 522 may be adjusted for motion throughout a synthetic environment (e.g., a cityscape as shown in display 520). When pitch (i.e., full or partial rotation about a latitudinal axis (i.e., y-axis in a Cartesian coordinate system), roll (i.e., full or partial rotation about a longitudinal axis (i.e., x-axis in a Cartesian coordinate system)), yaw (i.e., full or partial rotation about a vertical axis (i.e., z-axis in a Cartesian coordinate system)), or any Cartesian coordinate is modified to adjust for motion and position at a given point in space, the recorded input to camera 522 is captured and sent to an encoder (e.g., encoder 112 (FIG. 1), video encoding server 222 (FIG. 2), data encoding server 326 (FIG. 3), encoding engine 416 (FIG. 4), video encoding server 418 (FIG. 4), or the like). Once sent to the encoder, the captured data may be further encoded for video, audio, or multimedia broadcast to other clients, as described herein.

In some examples, interface 502 may also be configured to present (i.e., display) camera controls 526 (e.g., play, stop, record, fast forward, fast rewind, pause, and others). Likewise, camera controls 526 may be presented on an interface associated with other clients when data is fed, streamed, or otherwise broadcasted from camera 522. In other examples, interface 502 and the above-described features may be configured differently and are not limited in function, structure, layout, design, implementation or other aspects to the examples shown and described.

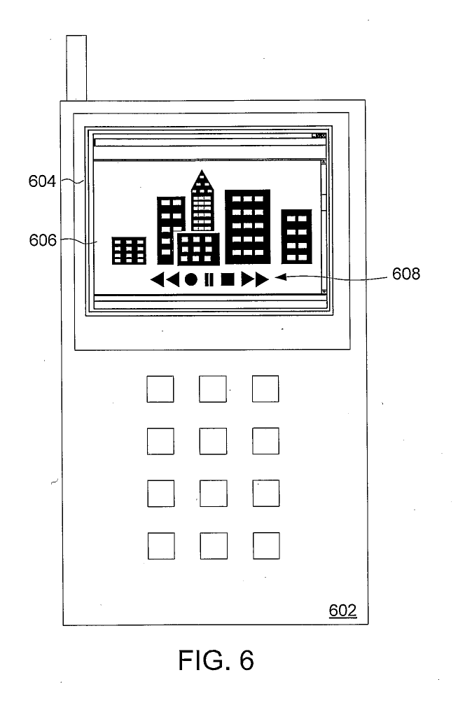

FIG. 6 illustrates an exemplary spectator view of synthetic environment broadcasting from the perspective of a broadcast-receiving client. Here, client 602 includes interface 604, display 606, and camera controls 608. In some examples, display 606 may be presented to appear similarly or substantially similar to display 520 in real-time or near real-time, as described above in connection with FIG. 5. Here, camera controls 608 may also be presented similarly or substantially similar to camera controls 526 (FIG. 5). In other examples, different elements, icons, widgets, or other graphical or displayed elements may be presented and are not limited to those shown and described. As shown here, display 606 is a substantially real-time broadcast (i.e., stream or feed) of “video” being encoded and transmitted from within a synthetic environment generated by, for example, application 200 (FIG. 2), application 300 (FIG. 3), application 400 (FIG. 4) of the like.

As an example, a client configured to receive a broadcast of data associated with an event occurring within a synthetic environment may be received on any type of device configured to receive a broadcast, stream, or feed encoded by encoder 112 (FIG. 1), or the like. Here, client 602 may be implemented as a mobile computing device, smart phone, PDA, iPhone™, or the like. Client 602 may also be implemented as a desktop, laptop, notebook, or netbook computer. Further, client 602 may also be a server configured to receive an encoded broadcast from within a synthetic environment. Here, a “live” (i.e., real-time or substantially real-time) broadcast, stream, or feed of data from a synthetic environment platform such as that described in U.S. patent application Ser. No. 11/715,009, which is herein incorporated by reference for all purposes, may be performed using the above-described techniques. By retrieving and encoding data associated with a synthetic environment, a broadcast, stream, or feed may be generated to clients, generating a display, perspective that is similar or substantially similar to the emulated game client that is recording the data that is generated by graphics engine 316 (FIG. 3). In other examples, client 602 and the above-described elements may be varied and are not limited to the descriptions provided.

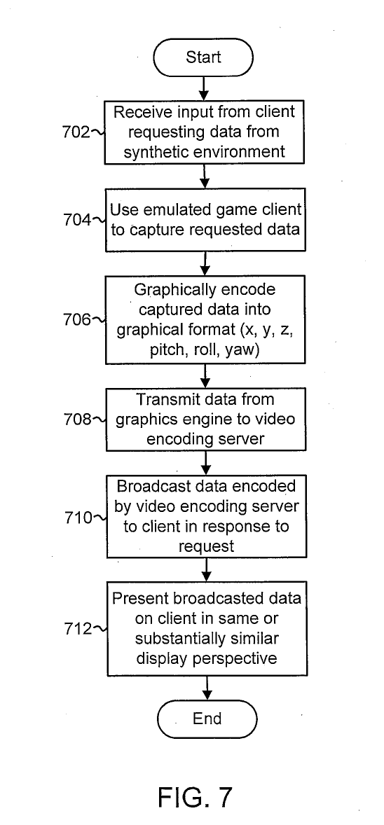

FIG. 7 illustrates an exemplary process for synthetic environment broadcasting. Here, an input (e.g., detection of a hyperlink (hereafter “link”) is received indicating a request by a client to receive a broadcast of data from a synthetic environment (702). In some examples, emulated game client 408 (FIG. 4) is used to capture the requested data (704). Once captured, the data is graphically encoded into a format including display parameters such as pitch, yaw, roll, x-coordinate, y-coordinate, z-coordinate, and others (706). Subsequently, the graphically encoded data is processed by graphics engine 316 to render the synthetic environment from the display perspective of emulated game client 408. The encoded data is transmitted from graphics engine 316 (FIG. 3) to, for example, video encoding server 418 (FIG. 4) (708) for video encoding prior to broadcasting. In other examples, other types of data (e.g., audio, multimedia, and others) may also be broadcast and the examples describing video data are not intended to limit the scope of the inventive techniques.

Once encoded by video encoding server 418, the encoded data is broadcast to the requesting client or clients. In some examples, a single client may activate a link that requests a download of data from a synthetic environment in order to broadcast a video feed. In other examples, multiple clients and, possibly, numerous (e.g., hundreds, thousands, millions, and the like) clients may request and receive broadcasts of data associated with a synthetic environment. In some examples, a broadcast may include a video feed of a given event within a synthetic environment. A broadcast may also include a stream or feed of data associated with a given user, character, player, account, or the like. In other examples, a broadcast may also be a request for a video feed of a scheduled event occurring within a synthetic environment (e.g., The Battle of Castle Bay, 7:00 pm PST/5:00 pm CST). In still other examples, when a broadcast is presented on a client, camera controls or user interface controls may be presented that allows a user to interactively control the broadcast (e.g., pausing and fast forwarding to catch up to the live action of a real-time or substantially real-time broadcast, stopping, recording, and others). A broadcast may be presented on a client in a display perspective that is substantially similar or similar to the display perspective from which it was captured. In some examples, the display perspective on a client may be interactively modified in order to allow the user the opportunity to change the perspective, camera angle, or frame of reference from which the broadcast is observed. Numerous other variations may be envisioned and are not limited to the examples shown and described herein. The above-described process may be varied in function, order, steps, or other aspects without limitation to the examples shown and described.

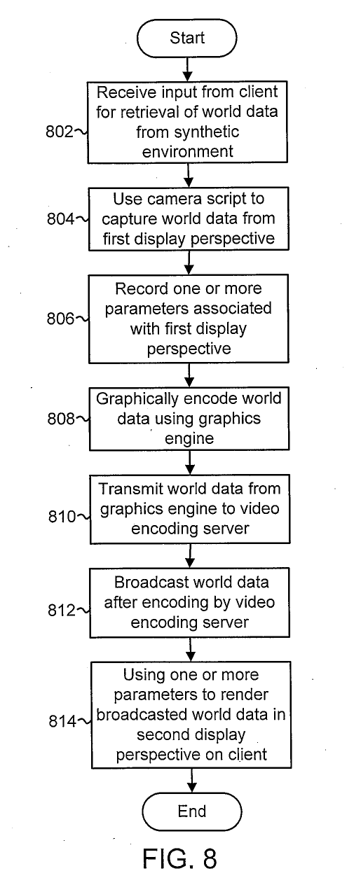

FIG. 8 illustrates another exemplary process for synthetic environment broadcasting. Here, an input is received from a client requesting world data from a synthetic environment (802). As used herein, “world data” refers to any type, category, encoding scheme, or format of data associated with a synthetic environment. Data may be contextually related to an event, character, region, opponent, account, or other aspect of a synthetic environment. Camera script 410 (FIG. 4) is used to record capture the requested world data from a first display perspective (i.e., the display perspective of emulated game client 408 (FIG. 4) (804). One or more parameters associated with the captured data and first display perspective is recorded (806). The captured world data is graphically encoded using encoding engine 416 (FIG. 4) (808). Once encoded and graphically processed to generate the requested graphics from the captured world data, the graphically processed world data is transmitted from a graphics engine (e.g., encoding engine 416) to video encoding server 418 (FIG. 4) (810). Once received by the video encoding server 418, the graphically processed world data is broadcast by the video encoding server to the requesting client(s) (812). In some examples, graphically processed world data may be transmitted to the video encoding server using an API or other interface to provide for interpretation of the graphically processed world data from a property class object system to a format associated with the video encoding server. In other examples, graphically processed world data may be transmitted to the video encoding server differently. Once received at the client, the broadcasted data (i.e., graphically processed world data) is presented on an interface associated with the client in a display perspective that is similar or substantially similar to the display perspective of the camera script that was used to capture the world data originally. The above-described techniques may be performed in real-time or substantially real-time (i.e., 15 seconds or less from the time of capture to presentation on a broadcast recipient (i.e., client)). In other examples, the above-described process may be varied and is not limited to the descriptions provided.

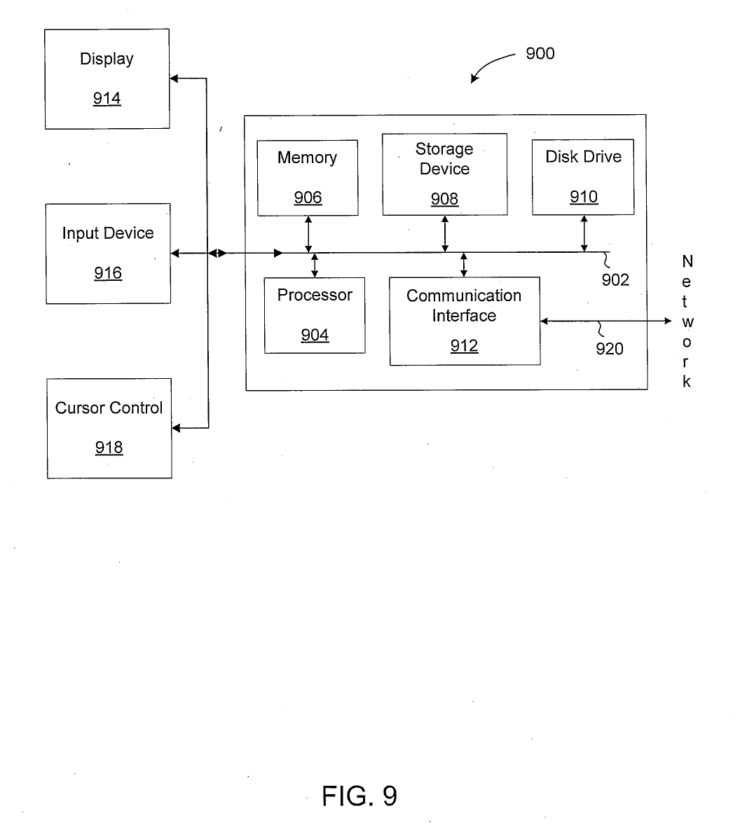

FIG. 9 illustrates an exemplary computer system suitable for synthetic environment broadcasting. In some examples, computer system 900 may be used to implement computer programs, applications, methods, processes, or other software to perform the above-described techniques. Computer system 900 includes a bus 902 or other communication mechanism for communicating information, which interconnects subsystems and devices, such as processor 904, system memory 906 (e.g., RAM), storage device 908 (e.g., ROM), disk drive 910 (e.g., magnetic or optical), communication interface 912 (e.g., modem or Ethernet card), display 914 (e.g., CRT or LCD), input device 916 (e.g., keyboard), and cursor control 918 (e.g., mouse or trackball).

According to some examples, computer system 900 performs specific operations by processor 904 executing one or more sequences of one or more instructions stored in system memory 906. Such instructions may be read into system memory 906 from another computer readable medium, such as static storage device 908 or disk drive 910. In some examples, hard-wired circuitry may be used in place of or in combination with software instructions for implementation.

The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks, such as disk drive 910. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by a single computer system 900. According to some examples, two or more computer systems 900 coupled by communication link 920 (e.g., LAN, PSTN, or wireless network) may perform the sequence of instructions in coordination with one another. Computer system 900 may transmit and receive messages, data, and instructions, including program, i.e., application code, through communication link 920 and communication interface 912. Received program code may be executed by processor 904 as it is received, and/or stored in disk drive 910, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
receiving an input from a client indicating a request to retrieve data associated with a synthetic environment;
using an emulated game client to capture data in a first display perspective associated with the synthetic environment;
graphically encoding the data captured by the emulated game client using a graphics engine, the data being encoded into a graphical format;
transmitting the data from the graphics engine to a video encoding server;
broadcasting the data after being encoded by the video encoding server to the client in response to the request, the data being broadcast in substantially real-time by the video encoding server; and
presenting the data being broadcast on the client, wherein the data is rendered on the client in a second display perspective that is substantially similar to the first display perspective.

2. The method of claim 1, wherein the data comprises video data.

3. The method of claim 1, wherein the data comprises audio data.

4. The method of claim 1, wherein the graphical format comprises one or more parameters.

5. The method of claim 4, wherein at least one of the one or more parameters comprises pitch.

6. The method of claim 4, wherein at least one of the one or more parameters comprises roll.

7. The method of claim 4, wherein at least one of the one or more parameters comprises yaw.

8. The method of claim 4, wherein at least one of the one or more parameters indicates a Cartesian coordinate.

9. The method of claim 1, wherein substantially real-time is equal to 15 seconds or less.

10. The method of claim 1, wherein the first display perspective is similar to the second display perspective.

11. The method of claim 1, wherein broadcasting the data further comprises streaming a video feed to the client in substantially real-time.

12. The method of claim 1, wherein the emulated game client is a camera script configured to capture video data associated with the synthetic environment.

13. The method of claim 1, wherein the emulated game client is configured to identify video data to be encoded, the video data being associated with a synthetic environment.

14. A method, comprising:
receiving an input from a client indicating a request to retrieve world data associated with a synthetic environment;
using a camera script instantiated on a first server to capture the world data in a first display perspective associated with the synthetic environment;
recording one or more parameters associated with the first display perspective;
graphically encoding the world data captured by the camera script using a graphics engine;
transmitting the world data from the graphics engine to a video encoding server;
broadcasting the world data after being encoded by the video encoding server to the client in response to the request, the world data being broadcast in substantially real-time by the video encoding server; and
using the one or more parameters associated with the first display perspective to present the world data being broadcast on the client, wherein the one or more parameters are used to present the world data on the client in a second display perspective that is substantially similar to the first display perspective.

15. The method of claim 14, wherein the request is associated with an event occurring within the synthetic environment.

16. The method of claim 14, wherein the emulated game client is hosted on a server.

17. The method of claim 14, wherein the video encoding server comprises a file server.

18. The method of claim 14, further comprising providing one or more interactive controls.

19. The method of claim 18, wherein at least one of the one or more interactive controls is play.

20. The method of claim 18, wherein at least one of the one or more interactive controls is pause.

21. The method of claim 18, wherein at least one of the one or more interactive controls is stop.

22. The method of claim 18, wherein at least one of the one or more interactive controls is record.

23. The method of claim 14, wherein transmitting the data from the encoding engine to a video encoding server is performed using an application programming interface.

24. The method of claim 23, wherein the application programming interface is a video encoding standard application programming interface.

25. A system, comprising:
a memory configured to store data associated with a synthetic environment; and
a processor configured to receive an input from a client indicating a request to retrieve the data associated with the synthetic environment, to use an emulated game client to capture data in a first display perspective associated with the synthetic environment, to graphically encode the data captured by the emulated game client using a graphics engine, the data being encoded into a graphical format, to transmit the data from the graphics engine to a video encoding server, to broadcast the data after being encoded by the video encoding server to the client in response to the request, the data being broadcast in substantially real-time by the video encoding server, and to present the data being broadcast on the client, wherein the data is rendered on the client in a second display perspective that is substantially similar to the first display perspective.

26. A system, comprising:
a database configured to store world data associated with a synthetic environment;
a game server configured to receive an input from a client indicating a request to retrieve the world data associated with the synthetic environment;
a camera script instantiated on a first server and configured to capture the world data in a first display perspective associated with the synthetic environment, the camera script being configured to also record one or more parameters associated with the first display perspective;
a graphics engine configured to graphically encoding the world data captured by the camera script, the graphics engine being configured to transmit the world data from the graphics engine to a video encoding server;
a video encoding server being configured to broadcast the world data in response to the request, the world data being broadcast in substantially real-time by the video encoding server; and
a client configured to use the one or more parameters associated with the first display perspective to present the world data being broadcast on the client, wherein the one or more parameters are used to present the world data on the client in a second display perspective that is substantially similar to the first display perspective.

27. A computer program product embodied in a computer readable medium and comprising computer instructions for:
receiving an input from a client indicating a request to retrieve data associated with a synthetic environment;
using an emulated game client to capture data in a first display perspective associated with the synthetic environment;
graphically encoding the data captured by the emulated game client using a graphics engine, the data being encoded into a graphical format;
transmitting the data from the graphics engine to a video encoding server;
broadcasting the data after being encoded by the video encoding server to the client in response to the request, the data being broadcast in substantially real-time by the video encoding server; and
presenting the data being broadcast on the client, wherein the data is rendered on the client in a second display perspective that is substantially similar to the first display perspective.

28. A computer program product embodied in a computer readable medium and comprising computer instructions for:
receiving an input from a client indicating a request to retrieve world data associated with a synthetic environment;
using a camera script instantiated on a first server to capture the world data in a first display perspective associated with the synthetic environment;
recording one or more parameters associated with the first display perspective;
graphically encoding the world data captured by the camera script using a graphics engine;
transmitting the world data from the graphics engine to a video encoding server;
broadcasting the world data after being encoded by the video encoding server to the client in response to the request, the world data being broadcast in substantially real-time by the video encoding server; and
using the one or more parameters associated with the first display perspective to present the world data being broadcast on the client, wherein the one or more parameters are used to present the world data on the client in a second display perspective that is substantially similar to the first display perspective.
